(19) United States
(12) Patent Application Publication
(10) Pub. No.: US 2010/0300114 A1
(43) Pub. Date: Dec. 2, 2010

(54) MEMBRANE SEPARATION

(75) Inventors: Ashish Balkrishna Mhadeshwar, Schenectady, NY (US); Scott Michael Miller, Clifton Park, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/474,296

(22) Filed: May 29, 2009

(51) Int. Cl. F01K 23/06; B01D 53/22; F02C 6/00

(52) U.S. Cl. 60/783; 95/45; 95/51; 96/10; 96/9; 60/39.12

(57) ABSTRACT

A method of operating a membrane separation module is provided that includes the steps of directing a feed stream comprising a first component into the membrane separation module to separate the first component by permeating it across a membrane; and introducing a second component into the feed stream such that the second component has a higher permeability through said membrane than the permeability of the first component through said membrane.

### BACKGROUND

The embodiments of the present invention relate to a membrane separation system and in particular a membrane separation system for separating a gas mixture.

Membrane separation methods involve transfer of a component of a fluid mixture across a membrane. The transfer may occur due to molecular size, chemical selectivity or other factors. Often a sweep stream is used to enhance the rate of separation.

Membrane separation can be carried out in different types of modules such as a hollow fiber membrane module and a spiral wound membrane module. Use of sweep streams in a hollow fiber module is simple, however, spiral wound membrane modules are much more complicated to use a sweep stream with. In certain environments, the use of spiral wound membrane modules would be advantageous. However, due to the difficulties of incorporating a sweep stream with the spiral wound membrane modules, the usage may be impractical. Previous efforts of incorporating a sweep stream into a spiral wound membrane module have given rise to complex internal arrangements. This has resulted in making the modules costlier and not easy to mass manufacture and hence these are not commonly practiced.

It is desirable to find methods of making existing membrane separation modules amenable to a sweep stream to increase separation rates without additional complexities or cost.

### BRIEF DESCRIPTION OF THE INVENTION

Briefly, according to one embodiment of present invention, a method of operating a membrane separation module is provided. The method includes the steps of directing a feed stream comprising a first component into the membrane separation module to separate the first component by permeating it across a membrane; and introducing a second component into the feed stream such that the second component has a higher permeability through said membrane than the permeability of the first component through said membrane. The second component with higher permeability may be referred to as more permeable component, “MPC”.

Another embodiment of present invention provides for a method of separating CO₂ from an exhaust gas. The method includes steps of introducing the exhaust gas into a membrane gas separation module provided with a CO₂ separating membrane. A MPC component, having a permeability through the membrane higher than that of CO₂ is introduced into the exhaust gas before or during the step of introducing said exhaust gas into said membrane gas separation module.

According to yet another embodiment of the present invention, a spiral wound membrane separation module is provided that is configured to separate a component from gas mixture by permeating said component across at least one membrane. The spiral wound membrane separation module is provided with at least one feed port and at least one product port; and the at least one feed port is configured to receive the gas mixture and a MPC component. The MPC component is selected to have a permeability higher than the component to be separated. Some embodiments of the present invention also provide for method of retrofitting existing spiral wound membrane separation modules to improve rates of separation.

One embodiment of the present invention also describes an Integrated Gasification Combined Cycle (IGCC) system that includes a gasifier to generate syngas from a carbonaceous feedstock, a gas cleanup unit, a carbon dioxide separation unit configured to receive said steam enriched syngas and a combined cycle power plant configured to use said syngas. A steam content adjustment unit is provided to generate a steam enriched syngas before it is directed to a carbon dioxide separation unit with at least one CO₂ permeable membrane separation unit.

### DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic of a membrane separation module.

FIG. 2 is a schematic of a membrane separation process with a sweep stream.

FIG. 3 is a schematic of a hollow fiber membrane module.

FIG. 4 is a schematic of a spiral wound membrane separation module.

FIG. 5 is a schematic of a membrane separation process according to one embodiment of the present invention.

FIG. 6 is a schematic of a membrane separation process according to another embodiment of the present invention.

FIG. 7 is a schematic of a membrane separation process according to yet another embodiment of the present invention.

FIG. 8 is a schematic of a multi-stage membrane separation process according to one embodiment of the present invention.

FIG. 9 is a schematic of a multi-stage membrane separation process according to another embodiment of the present invention.

FIG. 10 is a plot of percentage CO₂ separation against sweep flowrate.

FIG. 11 is a plot of percentage CO₂ separation against pressure levels of feed stream.

FIG. 12 is a plot of percentage CO₂ separation against pressure levels of sweep stream.

FIG. 13 is a plot of percentage CO₂ separation against ratio of permeabilities of steam and CO₂ across the membrane for a co-current flow module.

FIG. 14 is a plot of percentage CO₂ separation against ratio of permeabilities of steam and CO₂ across the membrane for a counter-current flow module.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value. In some instances, the term “about” can denote a value within a range of ±10% of the quoted value.

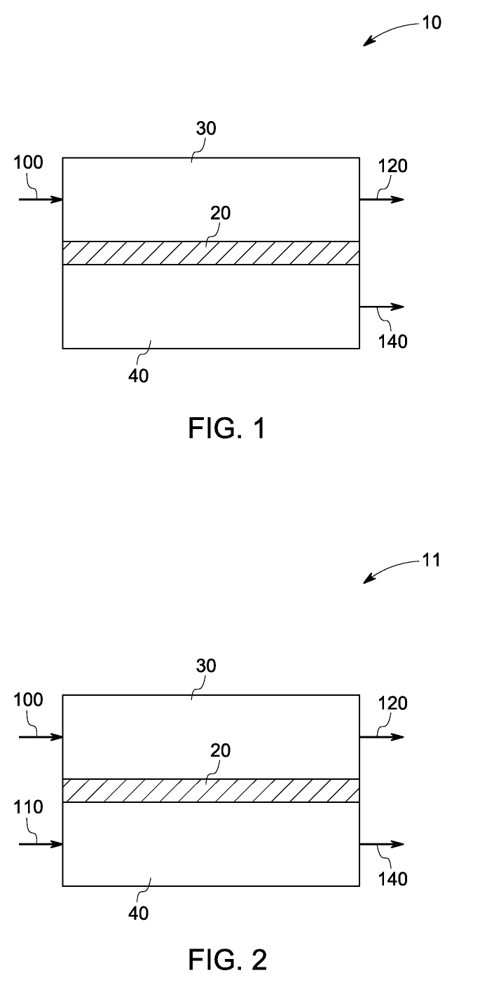

A membrane separation module can be schematically shown as in FIG. 1. The module 10 has a membrane 20 that divides the module into two regions—a retentate section 30, and a permeate section 40. The membrane module 10 separates a feed stream 100 into a retentate stream 120 and a product stream 140. For example, if the feed stream is assumed to be consisting of two components—A and B and if A is the component transported across the membrane 20, then compared to the feed stream 100, the product stream 140 is richer in component A and the retentate stream 120 is leaner in component A (has less concentration of A), thus effecting separation of the feed stream 100. The A-lean stream 120 is thus richer in component B compared to the feed stream 100. Depending on the selectivity (ratio of permeabilities of A and B) and degree of separation, the permeate stream 140 may substantially comprise component A and the retentate stream 120 may substantially comprise component B.

Often, to improve the driving force for transport of component A across the membrane, a sweep stream is applied to the permeate side of membrane. This is schematically shown in FIG. 2, where membrane separation module 11 includes a membrane 20 and the sweep stream 110 is introduced in the permeate section 40. The sweep stream 110 pushes the permeated molecules of component A downstream as the molecules are transported across the membrane, lowering the concentration of component A in the permeate section. The lowered concentration results in a higher driving force for the separation of component A across the membrane, leading to better separation rates.

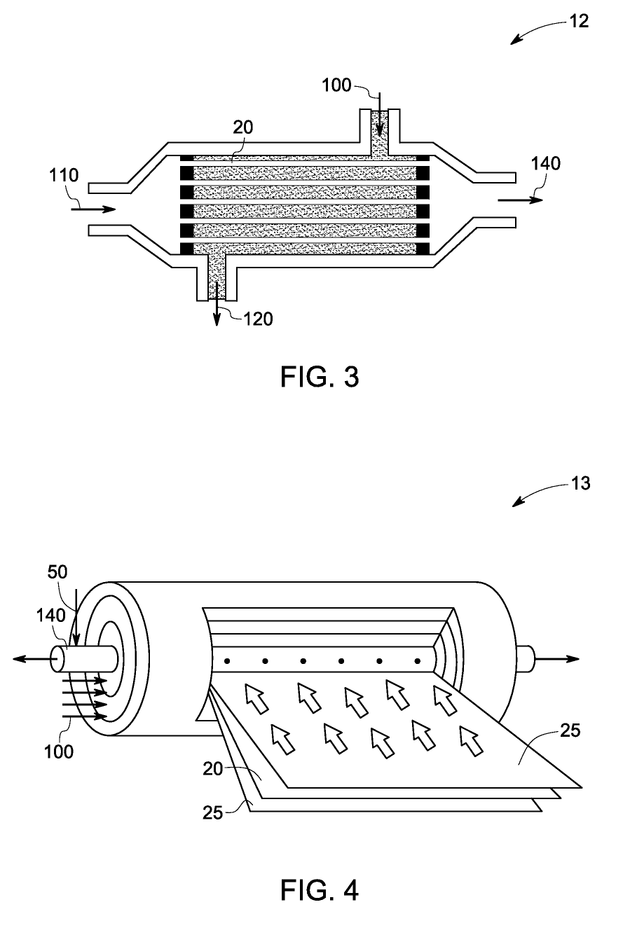

However, as discussed above, such an improvement of separation rates is practicable only in hollow fiber type membrane modules and not in current typical spiral wound membrane module configurations. FIG. 3 shows a schematic of a hollow fiber membrane module 12. Membrane 20 is in the form of a hollow fiber and a plurality of such membranes is arranged in parallel in a given module. The feed stream 100 is typically directed on the shell side and the transport of permeable component occurs across the walls of the membrane. The permeate stream 140 from all the membranes is collected and removed as a common stream. A sweep stream 110 facilitates removal of the permeated component and accelerates the separation as discussed earlier. In an alternate embodiment (not shown), the feed stream 100 is directed on the tube side (inside of hollow fiber 20) of the hollow fiber membrane module 12. Component A permeates across the membrane and is collected from the permeate side 40 (outside the hollow fiber). In either embodiments, a clearly defined, accessible permeate side is available and it is easy to introduce a sweep stream 110 on the permeate side of membrane 20.

FIG. 4 shows a schematic of a spiral wound membrane module 13. Typically, membrane 20 is sandwiched between two sheets 25, also called spacers. The membrane 20, along with the spacers 25 is wound around a perforated central collection tube 50. The feed stream 100 is circulated axially down the module across the membrane 20. A portion of the feed stream permeates through the membrane, where it spirals toward the center and exits through the collection tube 50. Thus, the permeate stream 140 is collected through the central tube 50 and the retentate stream 120 is collected at the other end of the membrane. A sweep stream, if introduced on one end of central collection tube 50, will push the collected permeate, but it does not sweep the permeate stream directly from the membrane surface and hence does not decrease the concentration of A at the permeate side of the membrane and therefore does not improve the separation rates. In an alternate embodiment (not shown), feed stream 100 may be introduced through the central pipe 50 and the permeate stream 140 is collected from the end of membrane 20. In either case since permeation occurs across the membrane surface that is not easily accessible due to the spiral structure, the introduction of a sweep stream over the membrane surface is difficult. Thus, a spiral wound separation module is not amenable to the incorporation of sweep gas on the permeate side of the membrane.

Spiral wound membranes are modules of choice especially due to their lower susceptibility to particle fouling and ease of manufacture. It is desirable to have arrangements that enable introducing a sweep stream (also referred to as “sweep” or “sweep gas”) in these spiral wound membrane modules to increase the separation rates. Previous efforts of incorporating a sweep have given rise to complex internal arrangements of feed spacers and permeate spacers in a spiral wound membranes and structuring of collection tube—which increases the cost of the modules and requires special manufacturing setups. Hence, these special spiral wound modules are not commonly practiced.

The embodiments of the present invention provide for a method of operating membrane modules with a sweep stream, without any major design changes in the membrane module itself.

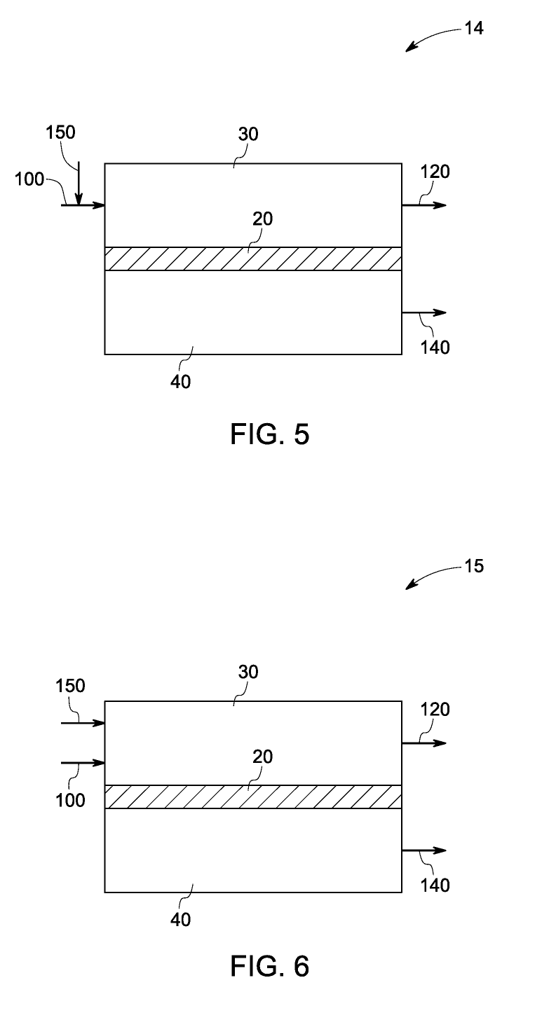

According to one embodiment of the present invention, a component “C” is introduced in the feed itself shown as stream 150 in FIG. 5, shown generally as 14. The component C is selected such that it has a higher permeability through membrane 20 than does component A. Due to its higher permeability, most of the component C is transported across the membrane 20 in the initial portion of the membrane 20. The component C, transported on the permeate side 40, moves the component A transported across the membrane 20 along the permeate side 40. This reduces the partial pressure (concentration) of component A on the permeate side 40, and results in an increase of the driving force for the separation of component A. Thus, component C (stream 150) effectively acts as a sweep stream. Thus, contrary to usual practice of providing the sweep component on the permeate side, the embodiments of the present invention provide for adding the sweep component in the feed itself.

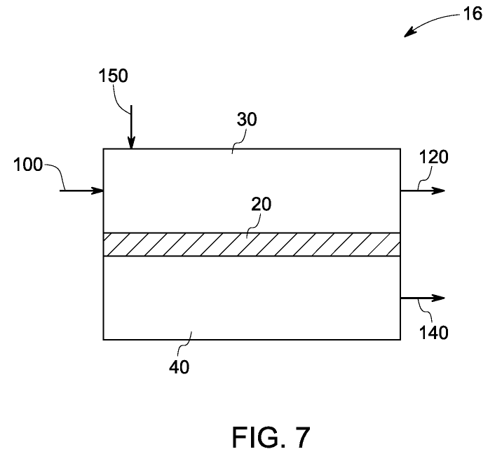

In alternate embodiments shown as 15 in FIG. 6, the sweep stream 150 may not be mixed with the feed stream 100 and introduced separately into the membrane module 15. Alternately, as shown in FIG. 7, the sweep component C, shown as 150, may be separately provided on the initial portion of retentate section 30, instead of being added to the feed stream 100 directly. The membrane module may be suitably altered, e.g., by providing appropriate feed ports etc., for introducing the sweep stream 150 before or during the introduction of feed stream 100 into the membrane module 16.

Addition of a sweep gas into the feed gas is counter-intuitive—since it dilutes the concentration of the desired component in the feed gas. However such modification facilitates separation, without any complexities, especially in spiral wound membrane modules. The specific arrangement and process provided by the embodiment of the present invention result in permeation of most of the sweep stream 150 (component C) in the initial region of membrane 20. Thus the dilution is temporary and over a short portion of the membrane, and the embodiment provides for better rates of separation due to the presence of the sweep stream. The embodiments of the invention are applicable not only to a spiral wound membrane module, but may also be used with any other configurations such as a hollow fiber module, a plate and frame module, and a monolithic membrane module.

A suitable sweep component C needs to be selected for a given membrane and the gas mixture being separated. The first consideration is the permeability of the sweep component across the membrane. The permeability of component C needs to be higher than the permeability of component A for a given membrane 20. Thus, component C may be termed as more permeable component (MPC).

In some embodiments, the sweep component C should be easily separable from the component A after the membrane separation process. If the separation of components A and C is not simple, alternate elaborate separation mechanisms may be required.

In some embodiments, if the mixture of components A and C may be used directly in some applications, or if it may simply be discarded, the requirement of separability of A and C is not stringent.

In one embodiment, the feed stream 100 is a CO₂-containing gas mixture. Feed stream 100 is fed to a membrane separation system 10 provided with a CO₂ selective membrane 20. Various CO₂ selective membranes are known in the art. Polymeric membranes such as those with ammonium moieties embedded physically or chemically may be used for such purposes. Suitable ceramic membranes made from CO₂ selective materials like hydrotalcite may also be used. Steam is added as the sweep component 150. Steam permeates faster than CO₂ across the membrane and acts like a sweep component. Thus it increases the rate of separation. A plurality of separation units may be used in series if higher degree of separation is desired. After separation, steam may be removed from the CO₂-steam (permeate) mixture simply by condensing the steam and removing the non-condensable CO₂.

Addition of steam also provides for hydration of membranes—keeping the membrane saturated with water. The presence of water (steam) may hydrate and swells the membrane, which results in improved separation efficiency. This is particularly true for polymeric membranes.

In some embodiments, a separate steam source as a sweep stream may not be required. For example—in an IGCC plant, syngas (a mixture comprising primarily CO and H₂) is produced by gasification of a carbonaceous feedstock. After gas cleanup, typically, the syngas is taken through a water gas shift (WGS) reactor to increase the hydrogen content of the gas. The gas cleanup unit may be a hot gas cleanup unit or a series of gas cleanup units that remove impurities like particulates, sulfur and other acid gases. In a WGS reactor, steam reacts with CO to produce additional hydrogen and CO₂. Thus, the product stream of a WGS reactor is a stream containing primarily CO₂ and H₂. Some amount of (unreacted) steam may also be present in the gas. The WGS reactor operates at elevated temperatures—typically a low temperature WGS reaction is carried out at about 190 deg C. to about 350 deg C. In one embodiment, the heat content of this gas is advantageously utilized in the separation of gas into components—CO₂ and H₂.

In one embodiment, water is introduced into the product stream of the WGS reactor. The introduction of water may be carried out using any suitable technique such as spraying the water into the gas stream, using a venturi tube, a packed tower, a trayed tower, or blowing the gas over water and the like. Water is added in a controlled quantity such that substantially all of the water introduced into the stream gets evaporated using the enthalpy of the stream. Thus, water addition results in cooling of the syngas and also introducing steam into the stream. The amount of water added to the stream may also depend on the steam content in the stream exiting the WGS reactor. Overall, the steam content adjustment of syngas may be done by using at least one of the outlined methods.

The steam laden CO₂—H₂ mixture is then introduced into a membrane separation unit—fitted with CO₂ separating polymeric membranes. As discussed previously, the steam permeates across the membrane faster than CO₂. The permeated steam acts as a sweep stream and facilitates the separation of CO₂ from the mixture as outlined in the previously discussed embodiments of the present invention. The retentate stream 120 is a hydrogen rich stream that may be sent to the combined cycle power plant. In some embodiments, a multi-stage membrane separation system may be employed.

Generically, this method of introduction of sweep component in the fluid stream may be applicable to other gas separation systems as well. In embodiments where the sweep component C boils at the temperature and pressure of the feed stream, it can be injected as a liquid and vaporized in the feed stream. In some other embodiments, the feed stream may be contacted with liquid phase component C, to saturate the feed stream with the maximum non-condensing level of C. This results in the cooling of the feed stream and as introduction of the sweep component as described in previous embodiments.

The embodiments of the present invention may be applied to separation of CO₂ from any exhaust stream. In one embodiment, the membrane separation module of FIG. 5 is used as a CO₂ capture mechanism for post-combustion CO₂ capture. For example, in a combined cycle power plant, fuel such as natural gas is used to produce hot gases in a combustion chamber. These gases drive a turbine and in turn produce electricity. The energy in the gases is further utilized to generate steam in a heat recovery steam generator (HRSG). The exhaust stream from HRSG is then expelled to atmosphere through a stack. The steam in turn drives a steam turbine and produces additional electricity. In one embodiment, at least a portion of low-pressure steam or condensate from the steam turbine is introduced into the exhaust stream from HRSG using any of the methods outlined above. Thus the HRSG exhaust stream is saturated with steam and sent to membrane separation modules such as those shown in FIG. 5, fitted with at least one CO₂ separating polymeric membrane. As discussed previously, the steam permeates faster than CO₂ and thus acts as a sweep stream. After separation of CO₂ to the desired level, the exhaust stream is expelled through the stack. The CO₂-steam mixture removed from the membrane separation modules is condensed to separate CO₂ and water. The water may then be sent for generation of steam, and CO₂ may be sent for sequestration or specific application. In some embodiments, CO₂ may be removed from only a portion of the exhaust stream.

Thus, adapting the membrane separation modules and process outlined by embodiments of the present invention do not disturb the closed loop use of water in a combined cycle power plant. This embodiment may be applicable not only for a combined cycle power plant, but for any exhaust stream, when a steam/water source is available. Depending on availability and suitability, any other gas or vapor may be used in this facilitated membrane separation technique.

In some embodiments, non-polymeric membrane based CO₂ separation modules are employed. In some embodiments, the exhaust stream from a coal based power plant, or a simple cycle gas turbine plant is adjusted for the steam content and sent to the membrane separation modules. The presence of steam into the exhaust stream provides for sweep functionalities as discussed previously, improving the CO₂ separation efficiency.

In one embodiment, the membrane separation module of FIG. 5 is used as a CO₂ capture mechanism for post-combustion CO₂ capture from a coal based power plant. A typical coal based power plant includes a boiler that combusts coal to generate steam; a flue gas also gets generated in the process. Often a superheated steam may be generated. The steam is used to drive steam turbines that in turn drive generators for producing electricity. Often multiple turbines—operating at High Pressure (HP), Intermediate pressure (IP) and Low Pressure (LP) steam are employed in series for better efficiency. The low-pressure steam turbine may produce a low pressure steam or a steam condensate. The embodiment outlined herein is applicable for any of the coal-based boilers, for example—pulverized coal, supercritical pulverized coal, fluidized bed, circulating fluidized bed and the like. In some embodiments, a supercritical steam generator may be used instead of a boiler.

The flue gas may be taken through at least one filter or ash removing mechanisms and a variety of heat recovery means such as economizer and air-preheater. Water (steam) content of the flue gas is adjusted by a variety of techniques. This may be achieved by introducing a portion of steam from low-pressure steam turbine, a portion of steam from intermediate pressure steam turbine or steam condensate or a combination of these into the flue gas. The introduction of steam or condensate may be achieved using any of the methods outlined above. Thus the flue gas is saturated with steam and sent to membrane separation modules such as those shown in FIG. 5, fitted with at least one CO₂ separating polymeric membrane. In some embodiments, saturation with water (steam) may be effected by cooling the flue gas.

As discussed previously, the steam permeates faster than CO₂ and thus acts as a sweep stream. After separation of CO₂ to the desired level, the exhaust stream is expelled through the stack. The CO₂-steam mixture removed from the membrane separation modules is condensed to separate CO₂ and water. The water may then be sent for generation of steam, and CO₂ may be sent for sequestration or specific application. In some embodiments, CO₂ may be removed from only a portion of the exhaust stream.

In one embodiment, a plurality of membrane separation units are arranged in series, when a higher level of separation is required. The product retentate and/or permeate stream of a first membrane separation module is sent to another membrane separation module, resulting in higher levels of purity. Multiple elements in parallel may be employed to process large volumes of feed gas. Series and parallel combinations of the membrane modules may be used to optimize the degree of separation and use of steam content in the feed gas.

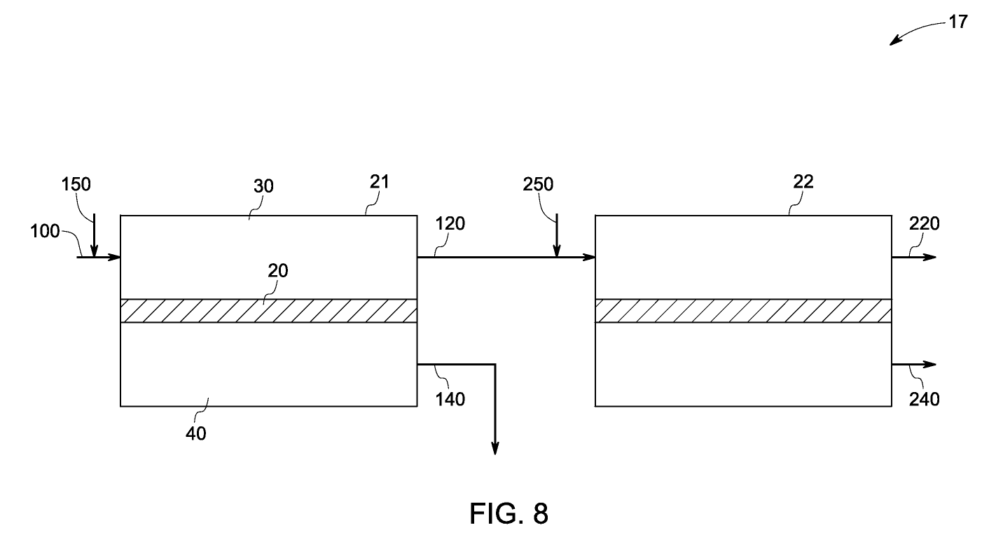

FIG. 8 shows a schematic of the membrane separation system 17 with two membrane modules—21 and 22. Each of the modules includes a membrane 20 and it is operated according to the embodiments outlined above. Thus, the feed stream 100 comprising A and B is directed to first module 21. Component A permeates across the membrane resulting in A-rich permeate stream 140 and retentate stream 120 richer in B compared to feed stream 100. The incorporation of sweep stream 150 as outlined in the previously described embodiments increases the rates of separation of component A. The retentate stream 120 is further sent to the second membrane module 22. Module 22 is operated similar to module 21, using a sweep stream 250, and producing a retentate stream 220, which is richer in component B as compared to stream 120 and a permeate stream 240, which is richer in component A as compared to stream 120. In some embodiments, more than two modules may be employed. The sweep stream may be used in some or all the membrane modules.

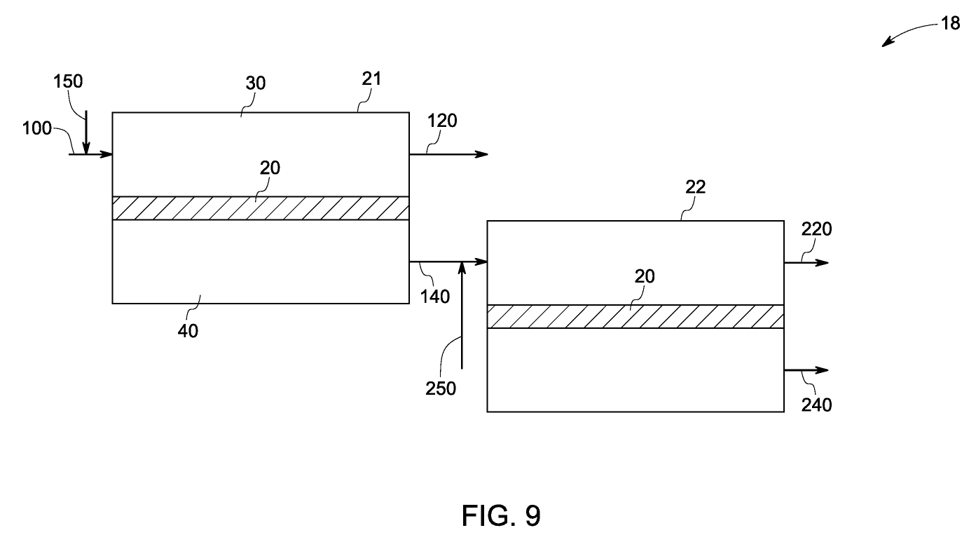

In another embodiment, the feed stream comprises components A and B. Component A permeates across the membrane to form a permeate stream. The A-rich permeate stream is then sent to another membrane module for further enrichment in component A. This is shown in FIG. 9. The membrane separation system 18 includes two membrane modules—21 and 22. Each of the modules includes a membrane 20 and it is operated according to the embodiments outlined previously. The A-rich permeate stream 140 is further sent to the second membrane module 22. Module 22 is operated similar to module 21, using a sweep stream 250, and producing a retentate stream 220, which is richer in component B as compared to stream 140 and a permeate stream 240, which is richer in component A as compared to stream 140. In some embodiments, more than two modules may be employed. The sweep stream may be used in some or all the membrane modules.

The embodiments above describe the use of a sweep component 150 (or 250) in a co-current flow module. In co-current operations, maximizing the permeability of (MPC) component C over that of component A is desirable. Component C rapidly passes through the membrane to reach equilibrium between the feed and sweep, achieving maximum dilution along the length of the membrane. The use of sweep on the feed side may also be practiced in counter-current flow membrane modules. In general, it is desirable that the MPC after permeation has a long path length. For co-current flow modules, it is achieved by using a sweep component with high permeability such that it permeates through the initial portion and flows for most of the membrane length on the permeate side. In counter-current configuration a sweep component C of intermediate permeability is chosen such that it does not completely permeate the membrane near the feed entry. Modules with cross-flow (like spiral wound modules) will see benefit between the counter-current and co-current limits. The selection of MPC component C depends on tradeoff between low filtration rates due to dilution of feed (retentate) and higher filtration rates due to dilution of permeate stream. The consideration for selection of the MPC component is not just the ratio of permeabilities, but it is also dictated by the parameters like performance of the membrane, module design and the like.

The embodiments of this invention may be applied to any type of membrane system—irrespective of the separation mode. The separation may be based on Knudsen diffusion of permeate molecules across the membrane, facilitated transport, molecular sieving, solution diffusion, or any other mechanism. The membrane employed may be a ceramic membrane, a polymeric membrane, or a composite membrane such as a mixed-matrix membrane. As discussed previously, the embodiments may be applied to any type of membrane separation module—spiral wound, hollow fiber, plate and frame, monolithic, and the like.

Some embodiments of the present invention provide for a spiral wound membrane separation module that separates a feed stream by selectively permeating at least one component across the membrane. The module is adapted to provide the sweep functionality without the need of any special arrangements in the membrane cartridge itself.

In one embodiment, the module is provided with a feed port to introduce the feed stream into the module. In alternate embodiments, the module may be provided with a separate feed port for each of the spiral wound membrane. Similarly, the module provides for at least one product port for separation of the product stream. The spiral wound membranes may be arranged in series or parallel within the module and the module may be provided with baffles to separate the spiral wound membranes.

The module may be modified (retrofitted) to provide at least one additional port for introduction of a more permeable component (MPC component) that has a higher permeability than component(s) permeating across the membrane. In some embodiments, the arrangement of the port for the MPC component may depend on the arrangement of the feed ports. The MPC component permeates across the membrane and provides for a sweep functionality.

As discussed previously, the retrofit action may provide for a feed port for MPC component such that the sweep gas after permeation has a long path length. For co-current flow modules, it is achieved by using a component with a high permeability such that it permeates through the initial portion and sees most of the membrane length on the permeate side. In counter-current configuration, the MPC component of intermediate permeability is chosen such that it does not completely permeate through the membrane near the feed entry. The membrane gas separation modules may be arranged in series and/or parallel to achieve desired separation efficiencies.

In some embodiments, existing spiral wound membrane modules are retrofitted by enhancing membrane separation rates by addition of a more permeable fluid to the feed stream. As discussed previously, this provides for a sweep functionality within the spiral membrane module. The addition of a more permeable component may be done before the fluid is introduced into the module, or during the introduction of feed in the module. In some embodiments, a liquid form of MPC component may be added to the gas mixture to be separated using any of the techniques such as—venturi tube, a packed tower, a trayed tower, or blowing the gas over water, and the like. In some embodiments, the more permeable sweep component may be added into the module directly through a separate feed port. This port may be arranged in the immediate vicinity of the feed port or at a distance from the feed port.

In some embodiments, the method of addition of the sweep component to feed stream is practiced using a hollow fiber membrane module. In some embodiments, the method of addition of the sweep component to feed stream is practiced using a plate and frame membrane module.

### EXAMPLES

The following examples are presented to further illustrate certain embodiments of the present invention. These examples should not be read to limit the invention in any way. In these examples, the term ‘conventional method’ is used only for hollow fiber membrane modules with sweep added in the conventional sweep port on the permeate side.

Membrane based gas separation was modeled using a program written in Matlab® software from Mathworks Inc. The model was used to study the effects of introducing the sweep gas in the feed side. The model was also used to study effects of various parameters on the process.

### Example 1

A model was developed for separation of CO₂—N₂ mixture into its components—CO₂ and N₂. The CO₂—N₂ mixture stream is sent to a co-current flow, hollow fiber membrane separation module equipped with CO₂ selective membranes. The permeability of CO₂ through the membrane is about 110 barrer. The model is based on a feed flow of about 88000 lbmol/hr with about 14 mol % of CO₂ and about 75 mol % of N₂, approximately equivalent to exhaust gas flow from a 300 MW power plant. The feed stream is available at a pressure of 200 psia. A single membrane module has a membrane surface area of 100 m² and 1000 such modules in parallel are used to process the available feed flow. Thus total membrane area available for separation is 0.1 km². Steam is used as a sweep fluid, noting the fact that permeability of H₂O:CO₂ is 100. Thus, steam quickly permeates through the membrane acting as a sweep fluid as described in the embodiments of the present invention. The separation of CO₂ and H₂O may be done by condensation of the product stream. The sweep stream was available at a pressure of 14.7 psia (1 atmosphere) and the flow of the sweep stream was varied between about 0 to about 20000 lbmol/hr.

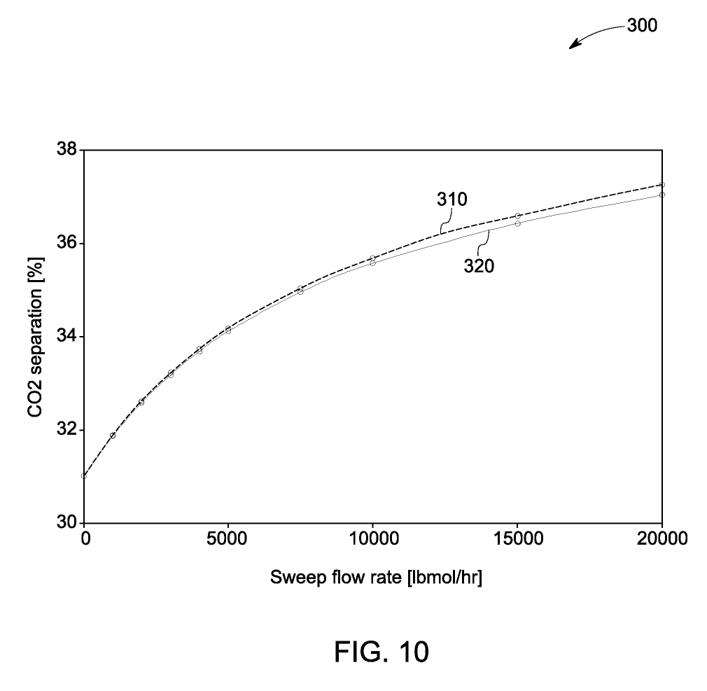

FIG. 10 is a graph—shown generically as 300, which illustrates the effect of sweep flowrate (lbmol/hr) (shown as X-axis) on percent CO₂ separation (shown as Y-axis). Line 310 shows effect of adding sweep component (steam) on the permeate side (conventional method) and line 320 shows the effect of adding sweep component (steam) on the feed side (as suggested by embodiments of the present invention). It is seen that for lower sweep flow rates, performance—percent CO₂ separation is comparable in both the methods. Thus the embodiments of present invention provide for a comparable performance with less apparatus complexity (since no modification of existing equipment is required).

### Example 2

In the second example, effect of feed pressure on effectiveness of CO₂ separation is studied. Other parameters remain the same as the previous example, only the sweep flowrate is fixed at 20000 lbmol/hr and the feed pressure is varied between 100-300 psia.

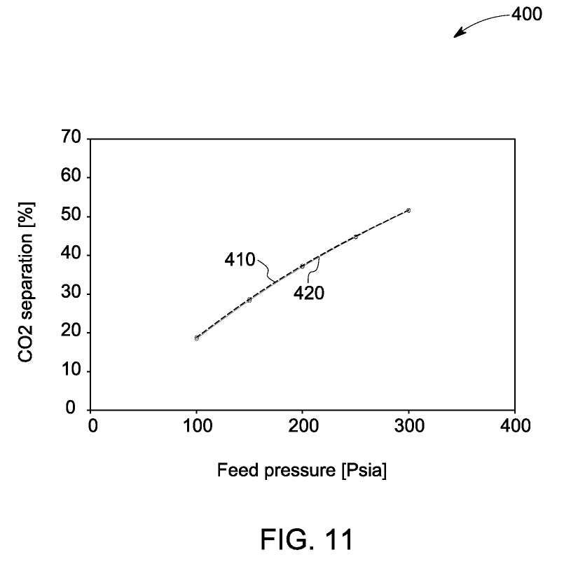

The results are shown in FIG. 11, which is a graph generically shown as 400. It illustrates the effect of feed pressure (shown as X-axis) on percent CO₂ separation (shown as Y-axis). Line 410 shows the effect of adding a sweep component on the permeate side (conventional method) and line 420 shows the effect of adding a sweep component on the feed side (as suggested by embodiments of the present invention). It is seen that for the addition of sweep stream on either side of the membrane produces the same CO₂ separation, irrespective of the feed pressure. Again, the embodiments of present invention provide for a comparable performance with less apparatus complexity (since no modification of the existing equipments is required).

### Example 3

In this example, the effect of sweep pressure on effectiveness of CO₂ separation is studied. Other parameters are maintained at the same values as the previous example, only the sweep pressure is varied between about 14.7 psia to about 88.2 psia (about 1 atm to about 6 atm) and the feed pressure is fixed at 200 psia.

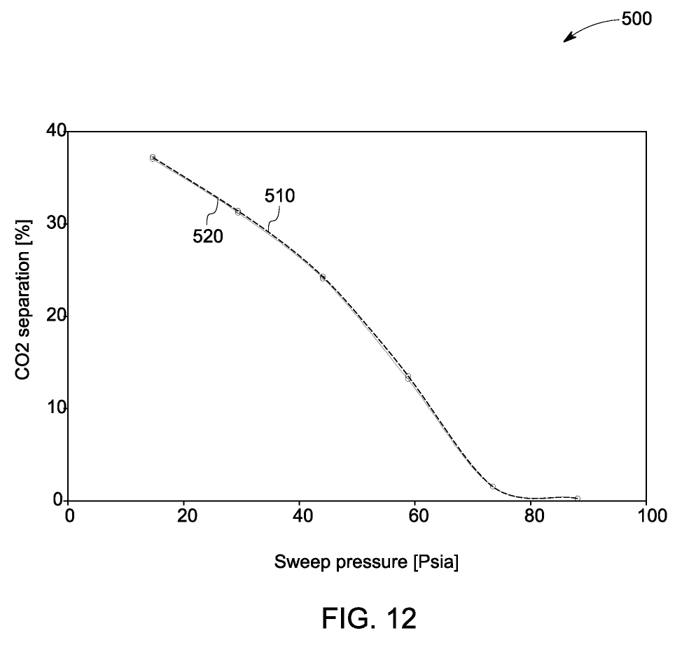

The results are shown in FIG. 12, which is a graph generically shown as 500, which illustrates the effect of sweep pressure (shown as the X-axis) on percent CO₂ separation (shown as the Y-axis). Line 510 shows the effect of adding a sweep component on the permeate side (conventional method) and line 520 shows the effect of adding a sweep component on the feed side (as suggested by embodiments of the present invention). It is seen that for both methods of operation, same CO₂ separation is obtained, irrespective of the sweep pressure. Yet again, the embodiments of present invention provide for a comparable performance with less apparatus complexity (since no modification of the existing equipments is required).

### Example 4

In this example, effect of permeability of the sweep component on effectiveness of CO₂ separation is studied. Other parameters are maintained at the same values as the previous example, only the ratio of the permeabilities (selectivity) of steam to CO₂ is varied between 1 and 100, and the sweep pressure is fixed at 14.7 psia. This provides a way to determine the effect of using different sweep components.

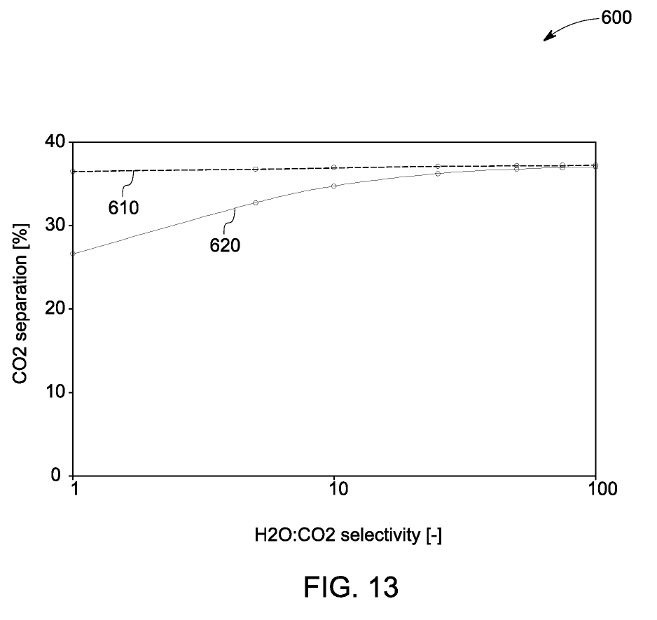

The results are shown in FIG. 13, generically shown as graph 600. It illustrates the effect of the ratio of permeability of sweep component to permeability of the component of the feed gas (primary component) permeating across the membrane. In this example, this is shown as the ratio of permeabilities (selectivity) of steam to CO₂ plotted on the X-axis and percent CO₂ separation is shown as the Y-axis. Line 610 shows the effect of adding a sweep component on the permeate side (conventional method) and line 620 shows the effect of adding a sweep component on the feed side (as suggested by embodiments of the present invention). It is seen that for the embodiments of present invention, the effectiveness of percent CO₂ separation increases as the ratio of permeabilities increases. At ratios of 100, the effectiveness of separation is comparable to conventional hollow fiber modules with a separately fed sweep. For spiral wound membrane module, the conventional method is no sweep. When compared to that case, even a ratio of about 3.6 is sufficient to improve the CO₂ separation.

### Example 5

In this example, a counter-current flow module was used. Except for the direction of flow, other parameters are maintained at the same values as outlined in Example 1. In this example, the effect of permeability of the sweep component on percent CO₂ separation is studied. The ratio of the permeabilities (selectivity) of steam to CO₂ is varied between 1 and 100, and the sweep pressure is fixed at 14.7 psia. This provides a way to determine the effect of using different sweep components in the counter-current mode.

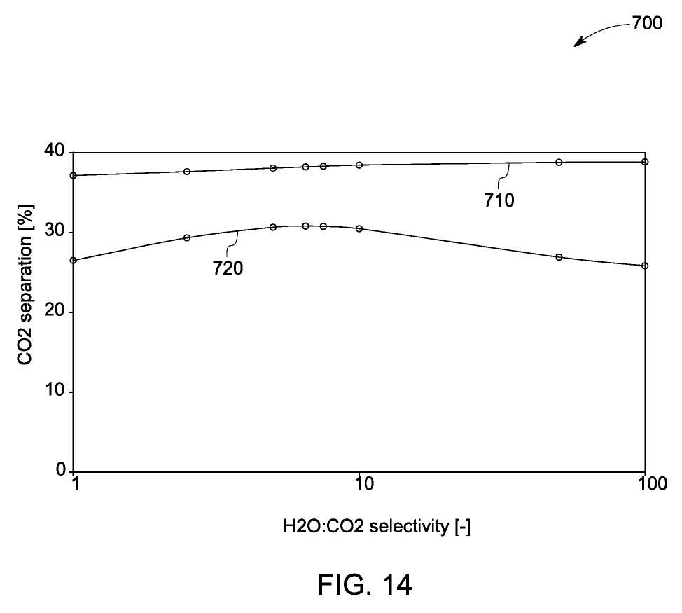

The results are shown in FIG. 14, generically shown as graph 700. It illustrates the effect of the ratio of permeability of sweep component to permeability of the component of the feed gas, permeating across the membrane. This is shown as the ratio of permeabilities (selectivity) of steam to CO₂ plotted on the X-axis and percent CO₂ separation is shown as the Y-axis. Line 710 shows the effect of adding a sweep component on the permeate side (conventional method) and line 720 shows the effect of adding a sweep component on the feed side (as suggested by embodiments of the present invention). The separation efficiency (percent CO₂ separation) passes through a maximum for the use of sweep component on feed side. As seen from graph 700, the percent CO₂ separation peaks at the selectivity value of about 6.5 for the MPC component. In contrast with results of co-current flow membrane separation module (shown in FIG. 13), where increase in the ratio of permeabilities (use of more and more permeable sweep component) increases the separation efficiency; for a counter-current configuration, the separation efficiency passes through an optimum. Increasing the permeability ratio beyond the optimum value does not increase the separation efficiency; on the contrary, further increasing permeability reduces efficiency. FIG. 14 shows the optimum for the configuration discussed above. In general, for a counter-current flow module, the optimum permeability of the MPC component will depend on factors such as mole fractions of the feed components, selectivities to other components, level of percent capture of the primary component, amount of sweep component added, pressures on the two sides of the membrane, etc.

As discussed previously in the embodiments of the present invention, the sweep stream with MPC component C is fed to the feed side. It permeates to the permeate side of the membrane and then acts as the sweep. It is desirable that the sweep gas after permeation has a long path length. For co-current flow modules, it is achieved by using a component with high permeability such that it permeates through the initial portion and sees most of the membrane length on the permeate side. This is validated by the results in FIG. 13.

Relative efficiency is defined as the ratio of CO₂ separation for “Sweep in feed-side” process to CO₂ separation for “Sweep in permeate-side” process. This compares the relative performance of the process set out by embodiments of the present invention to the performance of conventional process using sweep on permeate side, for hollow fiber membrane modules.

The results of above examples may be summarized using relative efficiency. If the sweep component is added to the feed, the same improvement is observed in the new process as in conventional processes. For the entire sweep flowrate range, the relative efficiency of the new process is >99%. For the entire feed pressure range, the relative efficiency of the new process is >98%. For the entire sweep pressure range, the relative efficiency of the new process is >97%. The relative efficiency of the new process decreases with a decrease in H₂O:CO₂ selectivity. A H₂O:CO₂ permeability ratio (selectivity) of at least about 3.6 is required to use the process outlined in the embodiments of present invention for a co-current flow operation. The permeability ratio (selectivity) of about 6.5 has been found to be optimum for a counter-current flow operation. The relative efficiency of the process suggested by embodiments of the present invention is substantially similar to the standard process of introducing sweep component on the permeate side over a wide range of sweep flow rates, feed pressure, sweep pressure, and also extent of separation. All these benefits are made possible without use of any sophisticated and expensive units such as custom-made spiral wound units.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method of operating a membrane separation module comprising the following steps:
directing a feed stream comprising a first component into said membrane separation module to separate said first component from said feed stream by permeating said first component across a membrane; and
introducing a second component into said feed stream, said second component having a higher permeability through said membrane than the permeability of said first component through said membrane.

2. The method of claim 1, wherein the ratio of permeability of said second component through said membrane to the permeability of said first component is at-least about 3.6.

3. The method of claim 1, wherein said membrane separation module is a co-current flow membrane separation module.

4. The method of claim 3 wherein said membrane separation module is a co-current flow hollow fiber membrane separation module.

5. The method of claim 1, wherein said membrane separation module is a counter-current flow hollow fiber membrane separation module.

6. The method of claim 1, wherein said membrane separation module is a spiral wound membrane separation module.

7. A method of separating a first component from a gas stream comprising:
flowing said gas stream over a membrane having a retentate side and a permeate side to permeate said first component to said permeate side of said membrane during separation; and
introducing a second component, having a higher permeability through said membrane compared to said first component, into said gas stream before or during said flowing of said gas stream over said membrane.

8. The method of claim 7, wherein the permeability of said second component through said membrane is at least about 3.6 times the permeability of said first component through said membrane.

9. The method of claim 7, wherein said membrane is disposed in a spiral wound membrane separation module.

10. The method of claim 7, wherein said membrane is disposed in a co-current or counter-current flow hollow fiber membrane separation module.

11. A method of separating CO₂ from an exhaust gas comprising:
introducing said exhaust gas into a membrane gas separation module, said gas separation module provided with a membrane capable of separating CO₂ by permeation through said membrane; and
mixing a component, having a higher permeability through the membrane than CO₂, into said exhaust gas before or during the step of introducing said exhaust gas into said membrane gas separation module.

12. The method of claim 11, wherein said component comprises steam.

13. A spiral wound membrane separation module configured to separate a component from gas mixture by permeating said component across at least one membrane;
said spiral wound membrane separation module provided with at least one feed port and at least one product port; and
said at least one feed port is configured to receive said gas mixture and a MPC component, said MPC component selected to have a permeability higher than said component to be separated.

14. A method of retrofitting a spiral wound membrane module for separating a gas mixture by permeating a component across membrane, said method comprising:
providing at least one means for adding a component having a higher permeability relative to said component to said separation module before or during injection of said gas mixture into said spiral wound membrane module.

15. A multistage gas separation unit comprising at least a first membrane separation module and a second separation module;
said first membrane separation module configured to receive a gas stream and permeate a component from the stream across a membrane system to form a first product stream;
said second membrane separation module configured to receive first product stream and permeate said component across another membrane system;
said first membrane separation module and said second membrane separation module configured to receive another component with a permeability higher than said component.

16. An IGCC system comprising:
a gasifier to generate syngas from a carbonaceous feedstock;
a gas cleanup unit;
a steam content adjustment unit to generate a steam enriched syngas;
a carbon dioxide separation unit configured to receive said steam enriched syngas; and
a combined cycle power plant configured to use said syngas;
wherein said carbon dioxide separation unit comprises at least one CO₂ permeable membrane separation unit.

17. The system of claim 16, wherein said carbon dioxide separation unit is configured to introduce steam during or before sending said steam enriched syngas into said CO₂ permeable membrane separation unit.

18. A method of operating a combined cycle power plant comprising:
generating hot gases in a combustion chamber;
driving a turbine using said hot gases to generate electricity and produce a turbine exhaust;
generating steam in a HRSG using the heat content of said turbine exhaust to produce a HRSG exhaust stream;
driving a steam turbine using said steam to produce additional electricity and a steam condensate;
directing at least a portion of said HRSG exhaust stream to at least one membrane separation module provided with at least one CO₂ separating membrane; and
introducing said steam condensate in said HRSG exhaust stream upstream of said at least one membrane separation module.

19. A method of operating a coal based power plant comprising:
operating a boiler using coal to produce steam and a flue gas;
using said steam to drive a turbine to generate electricity and produce a low pressure steam;
directing at least a portion of said flue gas to at least one membrane separation module provided with at least one CO2 separating membrane; and
introducing at least a portion of said low pressure steam into said flue gas upstream of said at least one membrane separation module.
